(19) United States
(12) Patent Application Publication
(10) Pub. No.: US 2014/0030380 A1
(43) Pub. Date: Jan. 30, 2014

(54) Manufacturing Method for Food With Enhanced Taste and Method for Enhancing Taste of Food

(71) Applicant: AJINOMOTO CO., INC., TOKYO (JP)

(72) Inventors: Seiji Kitajima, Kanagawa (JP); Yuzuru Eto, Kanagawa (JP); Takaho Tajima, Kanagawa (JP)

(73) Assignee: AJINOMOTO CO., INC., TOKYO (JP)

(21) Appl. No.: 14/043,195

(22) Filed: Oct. 1, 2013

Related U.S. Application Data
(63) Continuation of application No. PCT/JP2012/059209, filed on Apr. 4, 2012.

(30) Foreign Application Priority Data
Apr. 4, 2011 (JP) 2011-083155

(51) Int. Cl. A23L 1/22

(52) U.S. Cl. CPC A23L 1/22091
USPC 426/46; 426/656; 426/650

(57) ABSTRACT

The present invention provides a production method of a food, which can effectively enhance a taste without conferring an unpreferable or undesirable flavor, and a method for enhancing a taste of food. The present invention provides a method of producing a food with an enhanced taste, including by adding a peptide mixture obtained by hydrolyzing, with an enzyme, a composition containing β-conglycinin, and a method of enhancing the taste of food, including a step of adding the peptide mixture.

This application is a Continuation of, and claims priority under 35 U.S.C. §120 to, International Application No. PCT/JP2012/059209, filed Apr. 4, 2012, and claims priority therethrough under 35 U.S.C. §119 to Japanese Patent Application No. 2011-0083155, filed Apr. 4, 2011, the entireties of which are incorporated by reference herein.

### BACKGROUND OF THE INVENTION

1. Field of the Invention

The present invention relates to a method of producing a food with an enhanced taste, which includes the step of using a peptide mixture that can be obtained by hydrolyzing a composition containing β-conglycinin, and a method for enhancing the taste of food.

2. Brief Description of the Related Art

Soybeans contain many high quality proteins, and are widely utilized as a source of superior protein. Miso and soy sauce, which contain a hydrolysate of soybean protein, can season food at a low cost and are widely used as basic seasoning capable of improving the taste of food. However, since soybean protein hydrolysate can have an undesirable flavor, a problem exists of conferring an undesirable taste when seasoning a food.

Improving the taste of food using kokumi is a known method for enhancing the basic taste without losing the balance of the taste of food. Kokumi is a taste that cannot be described by the five basic tastes—sweet, salty, sour, bitter, and umami—and cannot only enhance the basic tastes but can also enhance the marginal tastes of the basic tastes, such as thickness, growth (mouthfulness), continuity, harmony and the like. Conventionally, some methods for conferring kokumi have been reported, and include adding glutathione (Japan JP-B-1464928), glycopeptide (WO2004/096836), dipeptide and tripeptide (Journal of Agriculture and Food Chemistry, 2007, Vol. 55, 6712-6719, Journal of Biological Chemistry, 2010, Vol. 285, No. 2, 1016-1022), and the like. However, these methods for conferring kokumi are problematic in that they cannot be provided at a low cost, and the like.

The soybean protein complex is made up of various proteins which have macromolecular complex structures, and can be divided, for example, into proteins labelled 2S, 7S, 11S, 15S and the like, by a fractionation method based on the difference in the sedimentation coefficient by ultracentrifugation analysis. These proteins have various, different characteristics not only in physical properties but also in their function. For example, β-conglycinin, which is the main component of the 7S protein, has been reported to be capable of improving blood triglycerides (Journal of Atherosclerosis and Thrombosis, 2006, Vol. 13, No. 5, 486-490), and a soybean protein mixture containing selectively decomposed β-conglycinin has been reported to improve physical properties such as emulsifiability and the like (Japan JP-B-3417350). In addition, a peptide mixture obtained by hydrolyzing β-conglycinin was examined for an aggregation property (Journal of Agriculture and Food Chemistry, 1984, Vol. 32, 486-490), and furthermore, physiological functions such as feeding suppressive action and the like have been reported (WO2006/132273, Biochemical and Molecular Action of Nutrients, 2003, Vol. 133, 352-357). However, the ability of a hydrolysate of β-conglycinin to enhance the taste of food has never before been examined, nor has the ability of this compound to confer a kokumi effect.

### SUMMARY OF THE INVENTION

### Problems to be Solved by the Invention

In light of the background of the prior art described above, the present invention provides a production method of a food, which can be used more generally and can effectively enhance a taste without conferring an unpreferable or undesirable flavor, and a method for enhancing a taste of food.

### Means of Solving the Problems

A peptide mixture obtained by enzymatic hydrolysis of β-conglycinin, which is a 7S component of soybean protein, is described. This mixture further contains peptide(s) having a molecular weight range as measured by the gel filtration method, and has a known trichloroacetic acid (0.22M) solubilization rate, provides an effect of enhancing the taste of food, particularly an effect of conferring kokumi to food.

It is an aspect of the present invention to provide a method of producing a food composition with an enhanced taste, comprising adding to a food composition a peptide mixture obtained by hydrolyzing with an enzyme a second composition comprising β-conglycinin as a main component, wherein the range of the molecular weight of said peptide mixture is 2.6-9.4 kDa as measured by a gel filtration method, and wherein the peptide mixture has a trichloroacetic acid (0.22M) solubilization rate of 12.1-25.4%.

It is an aspect of the present invention to provide the method as described above, wherein the peak area of the peptide mixture is 4.5-42.0% of the total peak area.

It is an aspect of the present invention to provide the method as described above, wherein said hydrolyzing is performed at pH 2-11 and/or a temperature of 4-70° C.

It is an aspect of the present invention to provide the method as described above, wherein the second composition comprises not less than 80 wt % of β-conglycinin.

It is an aspect of the present invention to provide the method as described above, wherein the second composition is produced from a soybean with a high content of β-conglycinin.

It is an aspect of the present invention to provide the method as described above, wherein the soybean comprises 65 mg/g-400 mg/g of β-conglycinin in a dry weight.

It is a further aspect of the present invention to provide a method of producing a food composition with an enhanced taste, comprising adding to a food composition a peptide mixture obtained by grinding and deoiling a soybean with a high content of β-conglycinin to give an extract, and hydrolyzing the extract with an enzyme under the conditions of pH 2-11 and/or a temperature of 4-70° C.

It is a further aspect of the present invention to provide the method as described above, wherein the enzyme is selected from the group consisting of bromelain, papain, protease M, trypsin, aroase, and combinations thereof.

It is a further aspect of the present invention to provide the method as described above, wherein the enzyme is selected from the group consisting of bromelain, papain, protease M, and combinations thereof.

It is a further aspect of the present invention to provide the method as described above, wherein the concentration of the peptide mixture in the food composition is 0.001-99 wt %.

It is an aspect of the present invention to provide a food composition with an enhanced taste, which is obtained by a method as described above.

It is an aspect of the present invention to provide the food composition as described above, which is a seasoning.

It is an aspect of the present invention to provide a method for enhancing a taste of food, comprising adding to a food a peptide mixture obtained by hydrolyzing a composition comprising β-conglycinin as a main component with an enzyme.

It is a further aspect of the present invention to provide the method as described above, wherein the composition comprises not less than 80 wt % of β-conglycinin.

It is a further aspect of the present invention to provide the method as described above, wherein the peptide mixture comprises peptides having a molecular weight range of 2.6-9.4 kDa as measured by a gel filtration method.

It is a further aspect of the present invention to provide the method as described above, wherein the peptide mixture has a trichloroacetic acid (0.22M) solubilization rate of 12.1-25.4%.

It is a further aspect of the present invention to provide the method as described above, wherein the enzyme is selected from the group consisting of bromelain, papain, protease M, trypsin, aroase, and combinations thereof.

It is a further aspect of the present invention to provide the method as described above, wherein the composition is prepared from a soybean with a high content of β-conglycinin.

It is a further aspect of the present invention to provide the method as described above, wherein the method confers kokumi to the food.

It is a further aspect of the present invention to provide a peptide mixture obtained by grinding and deoiling a soybean with a high content of β-conglycinin to give an extract, and hydrolyzing the extract with an enzyme under the conditions of pH 2-11 and/or a temperature of 4-70° C.

It is a further aspect of the present invention to provide a taste enhancing agent comprising a peptide mixture obtained by hydrolyzing, with an enzyme, a composition comprising not less than 80 wt % of β-conglycinin, which mixture comprises a peptide having a protein molecular weight in a range of 2.6-9.4 kDa as measured by a gel filtration method, and shows a trichloroacetic acid (0.22M) solubilization rate of 12.1-25.4%.

It is a further aspect of the present invention to provide a food composition comprising a peptide mixture obtained by hydrolyzing, with an enzyme, a second composition comprising not less than 80 wt % of β-conglycinin under the conditions of pH 2-11 and/or a temperature of 4-70° C., said mixture

(1) comprises peptides having a molecular weight range of 2.6-9.4 kDa as measured by a gel filtration method,
(2) shows a peak area of the peptide of 4.5-42.0% of the total peak area, and
(3) has a trichloroacetic acid (0.22M) solubilization rate of 12.1-25.4%.

### Effect of the Invention

Using the peptide mixture derived from a β-conglycinin-containing composition, which is obtained as described herein, the taste can be effectively enhanced without conferring an unpreferable or undesirable flavor to a food, and kokumi can be conferred particularly effectively to food. In addition, since the peptide mixture can be prepared using general materials such as soybean and the like, it can be obtained at a low cost.

### BRIEF DESCRIPTION OF THE DRAWINGS

FIG. 1 shows the results of SDS electrophoresis of a hydrolysate of a β-conglycinin-containing composition, wherein the upper part of the stained gel shows the kind and concentration (μg/mL) of the enzyme used and the enzyme reaction time (min), and the left end shows the molecular weight (kDa) of the protein.

FIG. 2 shows the results of SDS electrophoresis of a soybean protein hydrolysate, wherein the upper part of the stained gel shows the concentration (μg/mL) of bromelain and the enzyme reaction time (min), and the left end shows the molecular weight (kDa) of the protein.

FIG. 3 shows the results of gel filtration chromatography analysis of hydrolysate C2 of a β-conglycinin-containing composition.

FIG. 4 shows the selection of fractions I-V based on the chart shown in FIG. 3, wherein the arrows show the fractionation starting points of fractions I-V.

FIG. 5 shows the results of SDS electrophoresis of fractions I-V, wherein the numeric values on the left end of the stained gel show the molecular weight (kDa) of the protein.

FIG. 6 shows a calibration curve obtained from the molecular weight of various protein markers and the elution time (retention time) measured by gel filtration chromatography, wherein the vertical axis of the graph shows the retention time (min) and the horizontal axis shows the molecular weight (kDa) of the protein.

FIG. 7 shows the relationship between the peak area rate in a protein molecular weight range of 2.6-9.4 kDa of hydrolysates C1-C6 of the β-conglycinin-containing composition, and a taste enhancing effect.

FIG. 8 shows the relationship between the trichloroacetic acid (TCA) solubilization rate of hydrolysates C1-C6 of the β-conglycinin-containing composition and a taste enhancing effect.

### DESCRIPTION OF THE PREFERRED EMBODIMENTS

β-conglycinin is a protein primarily found in 7S globulin, and which has a sedimentation coefficient of 7S by ultracentrifugation analysis. 7S globulin is a generic name of soybean soluble globular proteins. Therefore, β-conglycinin can also be referred to as 7S component. When β-conglycinin is the main component in a composition, the amount is generally not less than 20 wt %, not less than 40 wt %, not less than 50 wt %, not less than 80 wt %, or not more than 100 wt %, of protein content. The composition may also contain not more than 95 wt % or not more than 90 wt % of β-conglycinin in terms of protein content. While components other than β-conglycinin in the composition are not particularly limited, examples thereof include proteins such as glycinin, lipophilic protein, hemagglutinin, trypsin inhibitor, lipoxynase and the like, phytic acid, saponin, isoflavone, linoleic acid, lecithin and the like, and they can be present in the composition at an appropriate concentration. In addition to the above-mentioned components, the composition can contain, for example, water, organic solvents (alcohol such as ethanol, methanol etc., and the like), flavor, sugar, sweetener, fiber, vitamins, amino acids such as sodium glutamate and the like, nucleic acids such as inosine monophosphate and the like, inorganic salts such as sodium chloride etc., and the like.

A composition containing β-conglycinin as a main component, also referred to as “β-conglycinin-containing composition”, can be produced by, for example, fractionating a soybean component by using soybean as a starting material. Examples of the production method thereof include the method of Thanh et al. (Journal of Agriculture and Food Chemistry, 1976, Vol. 24, 1117-1121), the method of Vagano et al. which is an improved method thereof (Journal of Agriculture and Food Chemistry, 1992, Vol. 40, 941-944), the method of Saito et al. (Bioscience, Biotechnology and Biochemistry, 2001, Vol. 65, 884-887), and the like.

As the starting material of the β-conglycinin-containing composition, a soybean with a high content of β-conglycinin or an extract thereof can also be used. Specifically, the soybean with a high content of β-conglycinin can be a soybean species containing about twice the amount of β-conglycinin as compared to ordinary soybean, for example, 65 mg/g-400 mg/g, 100 mg/g-400 mg/g, in terms of dry weight. Examples of the soybean with a high content of β-conglycinin include, but are not limited to, “Nanahomare” (Nagano Vegetable and Ornamental Crops Experiment Station, The Hokuriku Crop Science, 2010, vol. 45, 61-64), and the like.

When a soybean with a high content of β-conglycinin is used as a starting material, the β-conglycinin-containing composition is not particularly limited; however, it can be obtained as, for example, an extract of a ground soybean with a high content of β-conglycinin by a deoiling treatment thereof according to the method described in the below-mentioned Examples. Since this method avoids a fractionation treatment of soybean protein and a purification treatment of β-conglycinin, it is preferable.

The β-conglycinin-containing composition can be produced as mentioned above or a commercially available product can also be used. Examples of commercially available products of the β-conglycinin-containing composition include Lipoff-700 (manufactured by FUJI OIL CO., LTD.) and the like. Moreover, β-conglycinin alone can also be used. As β-conglycinin, a commercially available product can be used, and specific examples thereof include β-conglycinin (manufactured by Sigma Aldrich Ltd.) and the like.

The β-conglycinin-containing composition can be directly, or after dissolution in a suitable solvent, subjected to hydrolysis with protease to give a peptide mixture. This peptide mixture can be referred to as the “peptide mixture of the present invention”.

While the solvent used to dissolve the β-conglycinin-containing composition is not particularly limited as long as it is an aqueous solvent, for example, water, saline, sugar water, citrate buffer, acetic acid aqueous solution, alcohol solution and the like, are examples. When water is used, warm water can also be used, and the temperature can be 4-100° C. While the concentration of β-conglycinin is not particularly limited, it can be 0.01-20 wt %, 0.05-10 wt %, 0.1-5 wt %, or 0.5-2 wt %. The β-conglycinin-containing composition does not need to be completely dissolved in a solvent, and may be partially or entirely suspended.

The protease that hydrolyzes the β-conglycinin-containing composition is not particularly limited as long as it has the property of decomposing β-conglycinin to produce peptide fragment(s). Examples of the protease include bromelain; papain; trypsin; proteases derived from the genus Aspergillus such as pepsin, pancreatin, protease P (manufactured by Amano Enzyme Inc.), protease M (manufactured by Amano Enzyme Inc.), Pantidase P (manufactured by YAKULT PHARMACEUTICAL INDUSTRY CO., LTD.) and the like; proteases derived from the genus Bacillus such as Thermoase, Neutrase (manufactured by Novozymes), aroase (manufactured by YAKULT PHARMACEUTICAL INDUSTRY CO., LTD.) and the like. An appropriately selected commercially available product can be used. In addition, two or more kinds of the above-mentioned proteases may be used in combination. Of these, bromelain, papain, protease M, trypsin and aroase are particular examples, bromelain, papain, protease M and aroase are further examples, and bromelain is a particular example, from the aspects of reactivity with β-conglycinin, a taste enhancing effect of the obtained peptide mixture and the like.

Conditions for reacting a protease with the β-conglycinin-containing composition can be appropriately selected and set, and are usually selected according to the chosen protease, since the optimal concentration, optimal temperature, optimal pH, reaction time and the like vary depending on the chosen enzyme. While these conditions are not particularly limited, the enzyme concentration can generally be 0.0001-100 mg/mL, 0.001-10 mg/mL, or 0.01-1 mg/mL; the reaction temperature can generally be 4-70° C., 10-70° C., or 15-70° C.; the reaction pH can generally be pH 2-11, pH 2.5-10.5, or pH 3-10; and the reaction time can generally be 30 sec-100 hr, 1 min-20 hr, or 15 min-360 min. In addition, when using bromelain as a protease, the enzyme concentration can be 0.0001-100 mg/mL, 0.001-10 mg/mL, or 0.01-1 mg/mL; the reaction temperature can be 4-70° C., 10-70° C., or 15-70° C., the reaction pH can be pH 2-11, pH 2.5-10.5, or pH 3-10, and the reaction time can be 30 sec-100 hr, 1 min-20 hr, or 15 min-360 min.

An inactivation treatment of protease can be performed after passage of a given reaction time. This prevents excessive hydrolysis of the β-conglycinin-containing composition, and can provide a peptide mixture of digested peptide fragments with appropriate molecular weights. The method for the inactivation treatment is not particularly limited and any known method can be used. Examples thereof include a method of inactivation by heat denaturation such as boiling and the like, denaturation of enzyme by pH, a method by the addition of an enzyme reaction inhibitor, and the like.

The peptide mixture can be obtained by hydrolyzing the β-conglycinin-containing composition with an enzyme as mentioned above. While the hydrolysis is not particularly limited, it can be performed such that a trichloroacetic acid (0.22M) solubilization rate of the peptide mixture obtained using the β-conglycinin-containing composition is 12.1-25.4%, or 19.5-24.00. Therefore, while the peptide mixture obtained by hydrolyzing the β-conglycinin-containing composition with an enzyme is not particularly limited, the trichloroacetic acid (0.22M) solubilization rate thereof can be 12.1-25.4%, or 19.5-24.00. The trichloroacetic acid solubilization rate is obtained by removing by precipitation a high molecular weight protein component in a trichloroacetic acid solution, and quantifying the low molecular weight protein component soluble in trichloroacetic acid, and can be used as an index showing the degree of protein hydrolysis (hydrolysis rate). While the measurement method of the trichloroacetic acid (0.22M) solubilization rate is not particularly limited, for example, the peptide mixture can be directly, or after dissolution or dispersion in a suitable solvent, added and mixed with a 0.44M trichloroacetic acid solution in an equal amount as the obtained solution. Then, the mixture can be incubated at 37° C. for 30 min, the precipitate removed using filter paper, the amount of dissolved protein in the filtrate quantified, and the proportion relative to the total amount of the protein in the sample can be determined, whereby the rate can be measured. The solvent used for dissolving or dispersing the peptide mixture is not particularly limited, and, for example, water, saline, sugar water, citrate buffer, aqueous acetic acid solution, alcohol solution and the like can be used. Also, the quantification of the protein is not particularly limited, and a method known per se, for example, Lowry method, Kjeldahl method, and the like can be used.

When the peptide mixture obtained above is preserved as a solution, it can be preserved at −20-4° C. In addition, the solution can also be freeze-dried and preserved in a powder state. When the peptide mixture is in a powder state, it can be preserved at −20-4° C., optionally with a desiccant such as silica gel and the like. When the peptide mixture is subjected to gel filtration chromatography, the preserved peptide mixture can be used directly or after dissolution in a suitable solvent. The solvent used for dissolving the peptide mixture is not particularly limited and, for example, water, saline, sugar water, citrate buffer, aqueous acetic acid solution, alcohol solution and the like are examples.

The peptide mixture can contain a peptide mixture having a molecular weight range of 2.6-9.4 kDa. The range of the molecular weight can be measured by, for example, a gel filtration method, i.e., gel filtration chromatography. The gel filtration chromatography can be performed using a method known to those of ordinary skill in the art under, for example, the following conditions. Column: Superdex 75 100/300 GL (manufactured by GE Healthcare), eluate: 20 mM phosphate buffer (pH 7.0), flow rate: 0.5 mL/min, column temperature: 25° C., detection: measurement of absorbance at wavelength 280 nm. As the analysis apparatus, high performance liquid chromatography apparatus, for example, high-performance liquid chromatography system LaChrom (manufactured by Hitachi, Ltd.) can be used.

The peptide(s) within the above-mentioned molecular weight range in the peptide mixture can be confirmed using protein markers having known molecular weights. For example, plural protein markers are analyzed under the same conditions as those for the gel filtration chromatography analysis of the peptide mixture, a calibration curve is drawn from the obtained elution time and the molecular weights of various protein markers, and the range of elution time corresponding to the above-mentioned molecular weight range can be determined from the calibration curve. Using the obtained range of the elution time as the standard, and from the chart obtained by gel filtration chromatography analysis of the peptide mixture, the peak of such peptide can be identified. The protein markers are not particularly limited as long as they can be used to prepare a calibration curve including the above-mentioned molecular weight range. For example, Conalbumin (75 kDa), bovine serum albumin (66 kDa), carbonic anhydrase (29 kDa), ovalbumin (43 kDa), ribonuclease A (13.7 kDa), Aprotinin (6.5 kDa), cyanocobalamin (1.36 kDa) and the like can be used in an appropriate combination. While these protein markers are not particularly limited, commercially available products can be used, and a kit containing plural protein markers and the like can also be used. The molecular weight range can also be examined using other approaches or methods.

In addition, the peptide(s) within the above-mentioned molecular weight range in the peptide mixture may have, for example, a peak area obtained by gel filtration chromatography of 4.5-42.0%, or 33-36%, of the total peak area. Here, the gel filtration chromatography is performed under the following conditions. Column: Superdex 75 100/300 GL (manufactured by GE Healthcare), eluate: 20 mM phosphate buffer (pH 7.0), flow rate: 0.5 mL/min, column temperature: 25° C., detection: measurement of absorbance at wavelength 280 nm. As the analysis apparatus, high performance liquid chromatography apparatus, for example, high-performance liquid chromatography system LaChrom (manufactured by Hitachi, Ltd.) can be used. The peak area can be determined from the chart obtained by gel filtration chromatography under the above conditions, and the peak area is set such that the molecular weight range is 2.6-9.4 kDa. To be specific, as mentioned above, using protein markers of known molecular weights, a calibration curve can be prepared to include the molecular weight range of 2.6-9.4 kDa, an elution time corresponding to the range of the protein molecular weight can be examined, and the peak area can be measured according to the obtained elution time. Appropriate protein markers can be as mentioned above, and the peak area can be measured according to the instruction manual of the chosen analysis apparatus. Along with the peak area (A), total peak area (B) obtained by subjecting the peptide mixture to gel filtration chromatography can be measured, and the proportion of the peak area (peak area rate) relative to the total peak area can be determined using the following formula. The total peak area can also be measured according to the instruction manual of the chosen analysis apparatus.

Peak area rate (%)=(A/B)×100

Moreover, a fraction having a molecular weight range of 2.6-9.4 kDa, which is obtained from the peptide mixture, can also be utilized. The fraction can be obtained, for example, by a gel filtration method according to a method similar to the method explained for the above-mentioned peptide, and identifying the elution time using protein markers of known molecular weights. A fraction eluted from the peptide mixture may be directly used or used after applying, to the obtained fraction, a known purification treatment such as concentration under reduced pressure, freeze-drying and the like, utilizing, for example, dialysis membrane, ultrafiltration membrane, microfiltration membrane, reverse osmosis membrane, or ion exchange membrane. These purification treatments can remove unnecessary components, which exert an influence other than the taste enhancing effect, from the obtained fraction. For example, dialysis using purified water can remove phosphoric acid and a salt thereof, as well as other salts from the obtained fraction, whereby the taste enhancing effect can be further enhanced. When dialysis is performed, for example, Tube-O-DIALYZER (manufactured by G-Biosciences), Slide-A-Lyzer (manufactured by Thermo Fisher Scientific Inc.) and the like can be utilized without particular limitation. Ultrafiltration membrane (manufactured by Millipore) and the like for ultrafiltration, MF membrane (manufactured by Millipore) and the like for microfiltration, RO membrane (manufactured by Millipore), and the like for reverse osmosis, and ion exchange membrane (manufactured by SUNACTIS CO., LTD.), and the like for ion exchange can be utilized. Commercially available products can be used. The peptide mixture may be the fraction per se, a fraction product containing said fraction, or an unfractionated product containing peptide(s) in said fraction.

The peptide mixture can enhance the taste of food effectively by addition thereof to the food, and can confer kokumi particularly effectively to the food. Accordingly, a method of producing a food with an enhanced taste is provided, including a step of adding the peptide mixture to food, and further, a method for enhancing the taste of food. Furthermore, a food composition is provided which contains the peptide mixture, and the food composition can have an enhanced taste.

The phrase “enhance the taste of food” means enhancing one or two or more of the five basic tastes of sweet, salty, sour, bitter and umami provided by food, and enhancing the marginal tastes of the basic tastes such as thickness, growth, mouthfulness, continuity, harmony and the like. “Kokumi” is a taste that cannot be expressed by the above five basic tastes, and has effects of not only enhancing the basic tastes but also enhancing marginal tastes of the basic tastes such as thickness, growth, continuity, harmony and the like. An action to enhance the taste of food can also be simply expressed as a “taste enhancing action”.

The amount of the peptide mixture to be added to food is not particularly limited as long as it can enhance the taste of food, and can be appropriately determined according to the kind of the food. For example, it can be added in an amount of 0.001-99 wt %, preferably 0.01-95 wt %, of the food.

The form of the peptide mixture to be added to food is not particularly limited, and can be determined according to the kind of the food. For example, it can be a powder, granule, liquid or paste.

The peptide mixture can be added to food at any time point such as before production of food (in the starting material), during production of food, after completion of food, immediately before eating food, during eating food, and the like.

The peptide mixture itself may be added to food as a starting material, or a starting material to which the peptide mixture is added can then be used as a starting material of food. For example, the peptide mixture itself can be used as a seasoning, or the peptide mixture can be added to a seasoning to enhance the taste of the seasoning. Moreover, the peptide mixture or a seasoning containing the peptide mixture can also be used as a starting material of soup and the like.

For example, when a seasoning solution is produced using the peptide mixture, the optimal amount of the peptide mixture, which varies depending on the seasoning solution containing the peptide mixture, can be determined by a simple preliminary trial. While the peptide mixture can be used directly, typically, a seasoning solution containing 10 wt % or so of the peptide mixture can be prepared, the seasoning solution is added to food at 0.001-5 wt %, and is mixed. The concentration of the peptide mixture in a seasoning solution can be appropriately determined depending on use, and the concentration of the seasoning solution to be added to food can be controlled according to the concentration.

The mode of utilization of the peptide mixture for food is not particularly limited, and may be added in the form of a seasoning to food and drink, mixed as a starting material of a powder, solid, or liquid seasoning, mixed as a starting material of processed foods, and the like. Examples of the food to which the peptide mixture is added include, but are not limited to, rice, rice ball, vegetable, pickles, tempura, boiled egg, snack, cereal, fried food, seasonings (seasoning salt, flavor seasoning, miso, soy sauce, dipping sauce, sauce, sauce, dressing, mayonnaise etc.), soups (cup soup, soup of instant noodle, etc.), processed foods such as roux and the like, seafood or meat processed products such as kamaboko, chikuwa, satsuma-age, ham, sausage and the like, and the like. The term “food” can also include beverage(s).

Based on the above-mentioned effects afforded by the peptide mixture, a taste enhancing agent containing the peptide mixture as an active ingredient and foods containing same are also provided.

The taste-enhancing agent characteristically contains the peptide mixture, and can enhance the taste of food effectively by addition thereof to the food, and can confer kokumi particularly effectively to the food. Therefore, the taste enhancing agent can also be utilized as a kokumi-conferring agent. The form of the taste enhancing agent is not particularly limited, and may be any form, including a liquid, paste, powder, granule and the like.

The peptide mixture may be directly used as a taste enhancing agent, or may be combined with a material other than the peptide mixture. When a material other than the peptide mixture is used, the concentration of the peptide mixture to be contained in the taste enhancing agent is not particularly limited and can be, for example, 0.001-99 wt %, or 0.01-95 wt %. Examples of the material other than the peptide mixture include additives usable for food such as an excipient, disintegrant, moisturizing agent, binding agent, isotonic agent, buffering agent, solubilizing agents, preservative, antioxidant, colorant, corrigent, coagulation agent, pH adjusting agent, and the like.

Examples of the excipient include starchy food additive and the like, examples of the disintegrant include cellulose calcium glycolate and the like, examples of the moisturizing agent include calcium stearate and the like, examples of the binding agent include cellulose and the like, examples of the isotonic agent include sorbitol and the like, examples of the buffering agent include sodium acetate and the like, examples of the solubilizing agents include cyclodextrin and the like, examples of the preservative include sodium nitrite and the like, examples of the antioxidant include L-ascorbic acid and the like, examples of the colorant include safflower dye and the like, examples of the corrigent include peppermint oil and the like, examples of the coagulation agent include magnesium chloride and the like, and examples of the pH adjusting agent include sodium lactate and the like. The taste enhancing agent can be formulated by adding various additives when needed for preparation.

The taste enhancing agent can be added to various foods, and specific examples include those similar to those exemplified above. The amount of the taste enhancing agent to be added to food is not particularly limited, and can be appropriately determined according to the kind or form of the food to which the agent is to be added. For example, it can be added such that the content of the peptide mixture is 0.001-99 wt %, or 0.01-95 wt %.

The peptide mixture can be used as a food taste enhancing agent or a kokumi-conferring agent as mentioned above, as well as a sweet taste enhancing agent, a salty taste enhancing agent, a sour taste enhancing agent, a bitter taste enhancing agent or an umami enhancing agent. All agents can be utilized in a similar mode as the taste enhancing agent.

### EXAMPLES

The present invention is explained in more detail by referring to the following non-limiting Examples. In the Examples, all sensory evaluations were performed by well-trained professional panelists who are engaged in the development of food.

1. Preparation of Hydrolysate of β-Conglycinin-Containing Composition and Soybean Protein Hydrolysate and Comparison of Taste Enhancing Effect

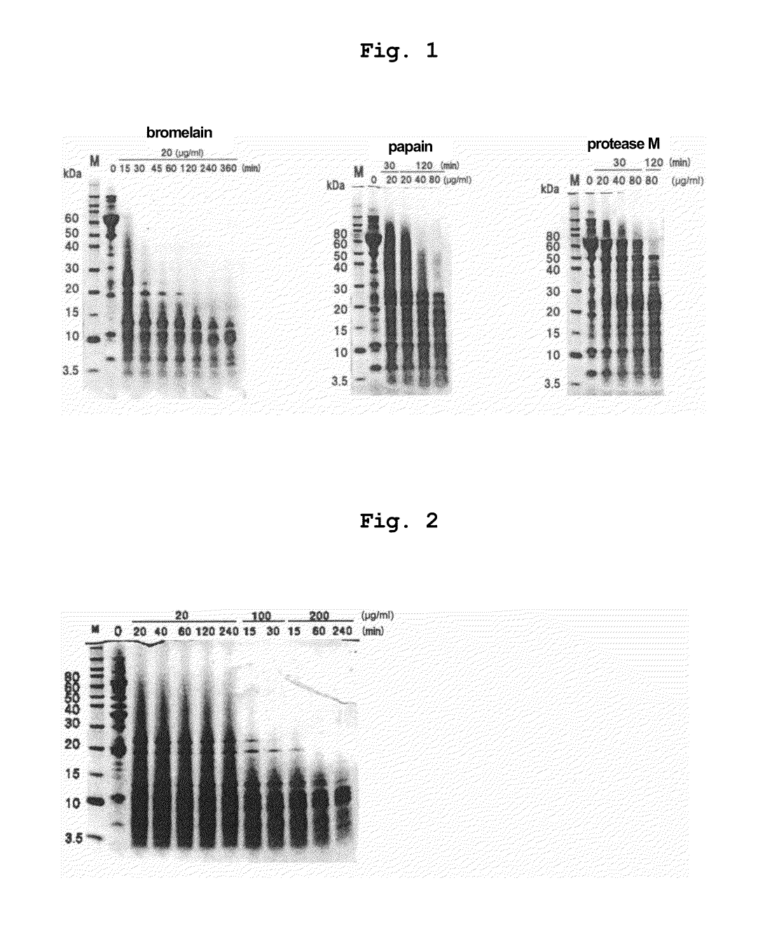

Warm water was added to Lipoff-700 (manufactured by FUJI OIL CO., LTD.) containing not less than 80 wt % of β-conglycinin to 1.0 wt % thereof, and the mixture was immediately stirred to complete dissolution and cooled to 37° C. Sodium hydroxide solution was then added to the mixture to adjust the pH to 7.0. To 1 L of this solution, bromelain (manufactured by BIOCON (JAPAN) LTD.), papain (manufactured by BIOCON (JAPAN) LTD.) or protease M (manufactured by Amano Enzyme Inc.) was added to 20-80 μg/mL, and the enzyme reaction was allowed to proceed for 15-360 min. The reaction mixture was then boiled to inactivate the enzyme activity, after which the reaction mixture was freeze-dried to give a powder hydrolysate (hereinafter referred to as “β-conglycinin hydrolysate”). The β-conglycinin hydrolysates were reduced with an SDS treatment solution containing 2-mercaptoethanol, subjected to SDS electrophoresis using 10% acrylamide gel (40 μg each lane), and then stained with CBB staining solution, and the level of degradation by enzyme was confirmed (FIG. 1).

Using Fujipro-F (manufactured by FUJI OIL CO., LTD.) as soybean protein, warm water was added thereto to 1.0 wt %, and the mixture was immediately stirred, completely dissolved and cooled to 37° C. Sodium hydroxide solution was then added to the mixture, and the pH was adjusted to pH 7.0. To 1 L of this solution, bromelain (manufactured by BIOCON (JAPAN) LTD.) was added to 20-200 μg/mL, and an enzyme degradation reaction was allowed to proceed for 15-240 min. The reaction mixture was then boiled to inactivate the enzyme activity, and then freeze-dried to give a powder soybean protein hydrolysate. The soybean protein hydrolysates were reduced with an SDS treatment solution containing 2-mercaptoethanol in the same manner as with the β-conglycinin hydrolysate, subjected to SDS electrophoresis using 10% acrylamide gel (40 μg each lane), and then stained with CBB staining solution, and the level of degradation by enzyme was determined (FIG. 2).

The level of degradation was confirmed from the SDS electrophoresis pattern, and then samples for the sensory evaluation of the β-conglycinin hydrolysate and soybean protein hydrolysate were selected as shown in Table 1, and the sensory evaluation was performed.

TABLE 1
β-conglycinin hydrolysate

| enzyme | — | bromelain | | | | | |
|---|---|---|---|---|---|---|---|
| sample | C0 | C1 | C2 | C3 | C4 | C5 | C6 |
| degrading | 0 | 20 | 20 | 20 | 20 | 20 | 20 |
| enzyme | | | | | | | |
| concentration | | | | | | | |
| (μg/ml) | | | | | | | |
| degradation | 0 | 15 | 30 | 60 | 120 | 240 | 360 |
| time (min) | | | | | | | |
| enzyme | papain | | | | | | |
| sample | C7 | C8 | C9 | C10 | | | |
| degrading | 20 | 20 | 40 | 80 | | | |
| enzyme | | | | | | | |
| concentration | | | | | | | |
| (μg/ml) | | | | | | | |
| degradation | 30 | 120 | 120 | 120 | | | |
| time (min) | | | | | | | |
| enzyme | protease M | | | | | | |
| sample | C11 | C12 | C13 | C14 | | | |
| degrading | 20 | 40 | 80 | 80 | | | |
| enzyme | | | | | | | |
| concentration | | | | | | | |
| (μg/ml) | | | | | | | |
| degradation | 30 | 30 | 30 | 120 | | | |
| time (min) | | | | | | | |

soybean protein hydrolysate

| sample | S0 | S1 | S2 | S3 | S4 | S5 | S6 | S7 | S8 |
|---|---|---|---|---|---|---|---|---|---|
| degrading | 0 | 20 | 20 | 20 | 20 | 100 | 100 | 200 | 200 |
| enzyme | | | | | | | | | |
| concentration | | | | | | | | | |
| (μg/ml) | | | | | | | | | |
| degradation | 0 | 20 | 40 | 120 | 240 | 15 | 30 | 15 | 60 |
| time (min) | | | | | | | | | |

Whole chicken stock (manufactured by Ajinomoto Co., Inc., 20 g) was dissolved in hot water (1 L), and the solution was divided into 100 ml portions. An evaluation sample (20 mg) was added to each of the portions, and mixed to give chicken soup with a concentration of 200 mg/L. Three professional panelists evaluated the chicken soup samples for their kokumi strength according to a rating method. The evaluation was performed using the sensory evaluation scores shown in Table 2 as the standard, and the evaluation scores of the three professional panelists were averaged to give evaluation results of the various samples. The results of the sensory evaluation are shown in Table 3. As the results of the sensory evaluation, not less than 3 points means “strong taste enhancing effect”, not less than 2 points and less than 3 points means “weak taste enhancing effect”, and less than 2 points means “no taste enhancing effect”.

TABLE 2
Sensory evaluation score

| | |
|---|---|
| 0.0 | No kokumi |
| 1.0 | Slight kokumi |
| 2.0 | Weak kokumi |
| 3.0 | Strong kokumi |
| 4.0 | Very strong kokumi |

TABLE 3
β-conglycinin hydrolysate

| enzyme | — | bromelain | | | | | |
|---|---|---|---|---|---|---|---|
| sample | C0 | C1 | C2 | C3 | C4 | C5 | C6 |
| sensory | 0.0 | 2.0 | 3.2 | 3.0 | 2.4 | 1.0 | 0.8 |
| evaluation | | | | | | | |
| score | | | | | | | |
| enzyme | papain | | | | | | |
| sample | C7 | C8 | C9 | C10 | | | |
| sensory | 1.7 | 2.0 | 2.0 | 1.8 | | | |
| evaluation | | | | | | | |
| score | | | | | | | |
| enzyme | protease M | | | | | | |
| sample | C11 | C12 | C13 | C14 | | | |
| sensory | 2.0 | 1.8 | 1.6 | 1.0 | | | |
| evaluation | | | | | | | |
| score | | | | | | | |

soybean protein hydrolysate

| sample | S0 | S1 | S2 | S3 | S4 | S5 | S6 | S7 | S8 |
|---|---|---|---|---|---|---|---|---|---|
| sensory | 0.0 | 1.0 | 1.5 | 0.8 | 0.5 | 0.4 | 0.4 | 0.4 | 0.4 |
| evaluation | | | | | | | | | |
| score | | | | | | | | | |

From the results shown in Table 3, a strong taste enhancing effect was observed in C2 and C3 for the β-conglycinin hydrolysates, and a weak taste enhancing effect was observed in C4, C8, C9 and C11. On the other hand, a taste enhancing effect was not observed in any sample of the soybean protein hydrolysates.

For the soybean protein hydrolysate, S2 was observed as having the highest evaluation score, and was evaluated a second time according to the above-mentioned method with increased sample concentrations of 400 mg/L, 600 mg/L and 1000 mg/L. However, a taste enhancing effect was not observed in any case (Table 4), and when the concentration was not less than 600 mg/L, an undesirable off-flavor was strongly observed. From the above results, the β-conglycinin hydrolysate was demonstrated to have a superior taste enhancing effect than the soybean protein hydrolysate.

TABLE 4

| | addition concentration | sensory evaluation |
|---|---|---|
| sample | (mg/L) | score |
| C2 | 200 | 3.2 |
| S2 | 200 | 1.5 |
| S2 | 400 | 1.9 |
| S2 | 600 | 0.6 |
| S2 | 1000 | 0.4 |

2. Taste Enhancing Component in β-Conglycinin Hydrolysate and Effect Thereof

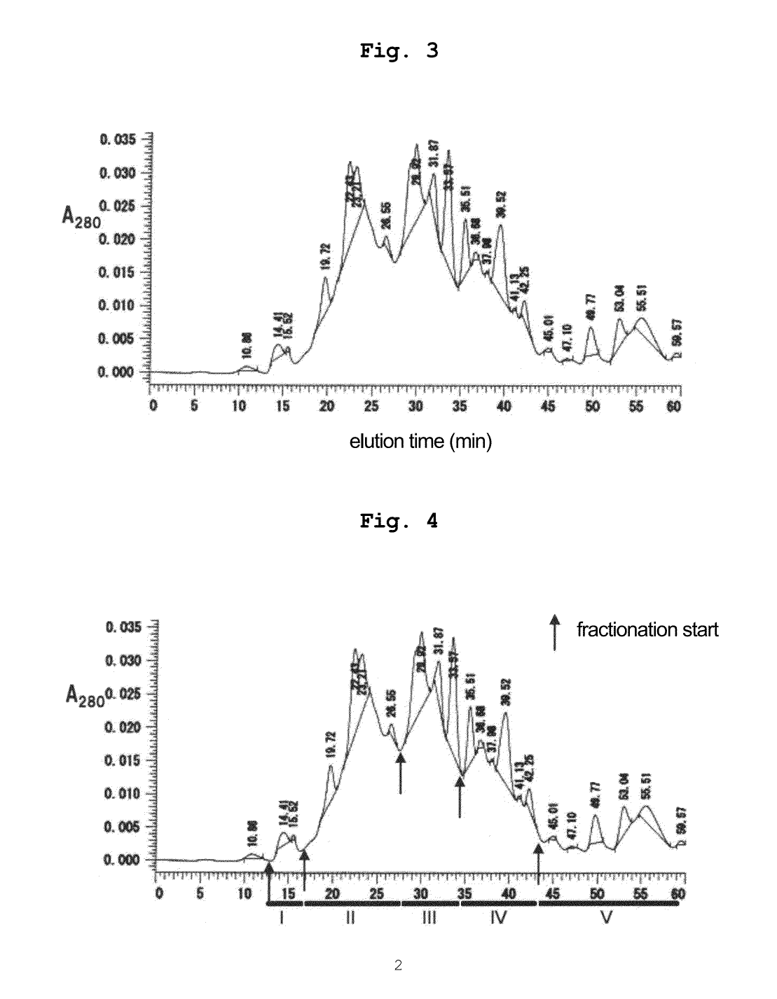

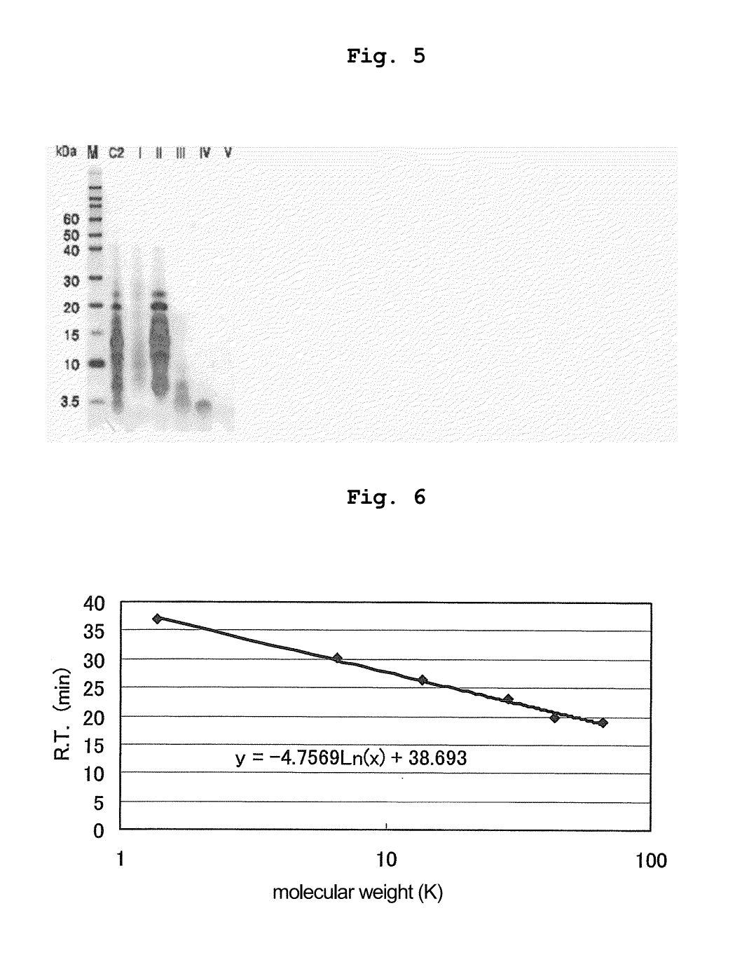

The C2 (40 mg) sample, which had the highest evaluation score among the β-conglycinin hydrolysates, was subjected to protein fractionation by gel filtration chromatography using high-performance liquid chromatography system LaChrom (manufactured by Hitachi, Ltd.). The gel filtration chromatography was performed under the following conditions. Column: Superdex 75 100/300 GL (manufactured by GE Healthcare), eluate: 20 mM phosphate buffer (pH 7.0), flow rate: 0.5 mL/min, detection: absorbance at measurement wavelength 280 nm. The results analyzed under these conditions are shown in FIG. 3. Based on the graph shown in FIG. 3, the fractionation start elution time of the fraction was set to 13.0 min, 17.0 min, 28.0 min, 34.0 min or 44.0 min, and fractions I-V were fractionated as shown in FIG. 4. The obtained fractions I-V were reduced with an SDS treatment solution containing 2-mercaptoethanol, subjected to SDS electrophoresis using 10% acrylamide gel, and then stained with CBB staining solution, whereby fractionation was confirmed (FIG. 5). The fractions I-V were dialyzed in purified water using a dialysis membrane Tube-O-DIALYZER (manufactured by G-Biosciences) to remove phosphoric acid and a salt thereof, and powderized by freeze-drying. The weight of the powder of each obtained fraction was as follows: I: 4.3 mg, II: 16.7 mg, III: 6.8 mg, IV: 7.2 mg, V: 9.4 mg.

The powderized fractions I-V were subjected to a sensory evaluation to examine which fraction contributes to the taste enhancing effect. Whole chicken stock (manufactured by Ajinomoto Co., Inc., 20 g) was dissolved in 1 L of hot water to prepare chicken soup, and the solution was divided into 200 ml portions. All of the obtained fractions I-V in powder (I: 4.3 mg, II: 16.7 mg, III: 6.8 mg, IV: 7.2 mg, V: 9.4 mg) were added to the chicken soup portions and mixed to achieve the same abundance ratio of β-conglycinin hydrolysate before fractionation. Three professional panelists evaluated the chicken soup samples for kokumi strength according to a rating method. The evaluation was performed using the sensory evaluation scores shown in Table 2 as the standard, and the evaluation scores of the three professional panelists were averaged to give evaluation results of fractions I-V. The results of the sensory evaluation are shown in Table 5. As the results of the sensory evaluation, a fraction showing a higher evaluation score was determined to have a stronger taste enhancing effect. In addition, the component in the fraction showing the highest evaluation score was determined to contribute the most to the taste enhancing effect of β-conglycinin hydrolysate.

TABLE 5

| sample | sensory evaluation score |
|---|---|
| C2 | 3.2 |
| I | 2.4 |
| II | 2.2 |
| III | 2.8 |
| IV | 2.0 |
| V | 1.5 |

As shown in Table 5, fraction III was found to confer the strongest taste enhancing effect, and this fraction was determined to contribute the most to the taste enhancing effect of β-conglycinin hydrolysate.

3. Range of Protein Molecular Weight of Taste Enhancing Component in β-Conglycinin Hydrolysate

To determine the range of the protein molecular weight of fraction III, a relational formula of the elution time and protein molecular weight was calculated by using the same conditions and method as the gel filtration chromatography shown in the above-described section 2, and a protein marker having a known molecular weight was used. As the protein marker having a known molecular weight, 66 kDa bovine serum albumin (manufactured by Sigma Ltd.), 29 kDa carbonic anhydrase (manufactured by DS Pharma Biomedical Co., Ltd.), 43 kDa ovalbumin (manufactured by Worthington), 13.7 kDa ribonuclease A (manufactured by Nacalai Tesque), 6.5 kDa Aprotinin (manufactured by Nacalai Tesque), and 1.36 kDa cyanocobalamin (manufactured by Wako Pure Chemical Industries, Ltd.) were used. As a result, the relational formula of the protein molecular weight and elution time was calculated as follows (FIG. 6).

y=−4.7569 Ln(x)+38.693

x: protein molecular weight (kDa), y: elution time (min)

The molecular weight range of fraction III (elution time 28.0-34.0 min) was determined using the above-mentioned relational formula to find 2.6-9.4 kDa. This range was taken as the molecular weight range of the taste enhancing component.

4. Relationship Between the Amount of Taste Enhancing Component in β-Conglycinin Hydrolysate and Taste Enhancing Effect

To examine the relationship between the amount of taste enhancing component in β-conglycinin hydrolysate and the taste enhancing effect, samples C1-C6 were analyzed using the same conditions and method as the gel filtration chromatography shown in the above-described section 2. From the obtained chromatography chart (vertical axis: absorbance, horizontal axis: elution time), the time during which the components at 2.6-9.4 kDa, which is the range of the protein molecular weight of the taste enhancing component, are eluted, i.e., peak area (A) eluted during the elution time of 28.0-34.0 min, was measured using the analysis software attached to HPLC system manager (manufactured by Hitachi, Ltd.). Also, total peak area (B) was measured from the chart, the peak area rate (%) of the taste enhancing component in samples C1-C6 was calculated using following formula.

peak area rate (%)=(A/B)×100

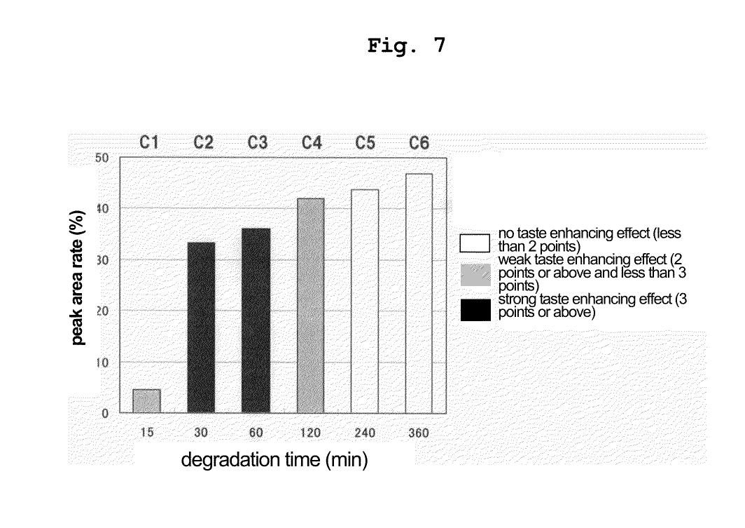

The peak area rates (%) of samples C1-C6 are shown in Table 6, and the relationship thereof with the taste enhancing effect by sensory evaluation shown in Table 3 is shown in FIG. 7.

TABLE 6

| sample | degradation time (min) | peak area rate (%) |
|---|---|---|
| C1 | 15 | 4.5 |
| C2 | 30 | 33.3 |
| C3 | 60 | 36.0 |
| C4 | 120 | 42.0 |
| C5 | 240 | 43.7 |
| C6 | 360 | 46.9 |

As a result, it has been determined that a taste enhancing effect is observed when the peak area rate is 4.5-42.0%. On the other hand, when the peak area rate was 43.7% or higher, a taste enhancing effect was not observed.

5. Relationship Between Taste Enhancing Effect of β-Conglycinin Hydrolysate and TCA Solubilization Rate

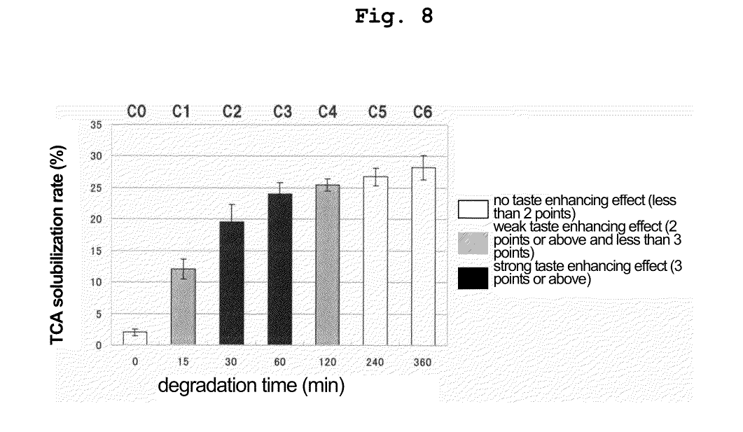

To examine the relationship between the taste enhancing effect of β-conglycinin hydrolysate and the hydrolysis rate, the trichloroacetic acid (TCA) solubilization rate, which is generally used as a hydrolysis rate, was measured for samples C0-C6. A powder of C0-C6 was dispersed in water at 1.0 wt %, and sufficiently stirred. To the solution was added an equal amount of 0.44M TCA (manufactured by Nacalai Tesque), and the mixture was sufficiently mixed and incubated at 37° C. for 30 min. Thereafter, the precipitate in the solution was removed with filter paper No. 5 (manufactured by ADVANTEC TOYO) to give a filtrate, and the amount of TCA (0.22M) soluble protein was measured by the Lowry method. Also, the total protein amount of each β-conglycinin hydrolysate was measured by the Lowry method. Using the measured TCA soluble protein amount and the total protein amount, the proportion of the amount of the TCA soluble protein to the total protein amount was calculated and the TCA solubilization rate was determined. The TCA solubilization rates of C0-C6 are shown in Table 7, and the relationship between these rates and the taste enhancing effect by sensory evaluation shown in Table 3 is shown in FIG. 8.

TABLE 7

| | degradation time | TCA (0.22M) solubilization |
|---|---|---|
| sample | (min) | rate (%) |
| C0 | 0 | 2.0 |
| C1 | 15 | 12.1 |
| C2 | 30 | 19.5 |
| C3 | 60 | 24.0 |
| C4 | 120 | 25.4 |
| C5 | 240 | 26.8 |
| C6 | 360 | 28.2 |

As a result, it has been determined that a taste enhancing effect is observed when the TCA solubilization rate is 12.1-25.4%. On the other hand, when the TCA solubilization rate is 2.0% or lower, or 26.8% or higher, a taste enhancing effect was not observed.

6. Taste enhancing effect of hydrolysate of β-conglycinin containing composition

Warm water was added to Lipoff-700 (manufactured by FUJI OIL CO., LTD.) containing not less than 80 wt % of β-conglycinin to 1.0 wt %, and the mixture was immediately stirred to complete dissolution and cooled to 37° C. Sodium hydroxide solution was added to the solution to adjust the pH to 7.0. To 1 L of this solution, trypsin (manufactured by Novozyme) or aroase (manufactured by YAKULT PHARMACEUTICAL INDUSTRY CO., LTD.) was added, which are different enzymes as compared to the above, to 20-80 μg/mL as shown in Table 8, and an enzyme reaction was allowed to proceed for 30-120 min. The reaction mixture was then boiled to inactivate the enzyme activity, and then the reaction mixture was freeze-dried to give a powder hydrolysate.

TABLE 8

| enzyme | |
|---|---|
| trypsin | aroase |

| sample | C15 | C16 | C17 | C18 |
|---|---|---|---|---|
| degrading enzyme | 20 | 80 | 20 | 80 |
| concentration (μg/ml) | | | | |
| degradation time (min) | 30 | 120 | 120 | 30 |

Whole chicken stock (manufactured by Ajinomoto Co., Inc., 20 g) was dissolved in hot water (1 L), and the solution was divided into 100 ml portions. Evaluation samples C15-C18 (20 mg) shown in Table 8 were added to the stock portions, and mixed to give chicken soup with a concentration of 200 mg/L for evaluation. Three professional panelists evaluated the chicken soup samples for their kokumi strength according to a rating method. The evaluation was performed using the sensory evaluation scores shown in Table 2 as the standard. The results are shown in Table 9.

TABLE 9

| sample | C15 | C16 | C17 | C18 |
|---|---|---|---|---|
| sensory evaluation score | 1.4 | 1.8 | 2.0 | 1.8 |

From the results shown in Table 9, a weak taste enhancing effect was observed in evaluation samples C15-C18.

7. Taste Enhancing Effect of Hydrolysate of Soybean with High β-Conglycinin Content

Commercially available soybean “NAYA” (manufactured by Prograin), and “Nanahomare” (Nagano Vegetable and Ornamental Crops Experiment Station, The Hokuriku Crop Science, 2010, vol. 45, 61-64), which contain about 2-fold of β-conglycinin as compared to general soybeans, were each ground in a powder by a coffee mill (manufactured by OSAKA CHEMICAL Co., Ltd.), and subjected to a deoiling treatment using Soxhlet (manufactured by Chitose Kagaku) and a solvent of n-hexane (manufactured by JUNSEI CHEMICAL CO., LTD.). After the deoiling treatment, they were dried to give a soybean extract and “Nanahomare” extract (hereinafter referred to as “soybean extract with high β-conglycinin content”). Warm water was added to the obtained extract to 1.0 wt %, and the mixture was immediately stirred, suspended and cooled to 37° C. To 1 L of this solution, bromelain to 20-80 μg/mL was added, and an enzyme reaction was allowed to proceed for 30 min. The reaction mixture was then boiled to inactivate the enzyme activity, after which the reaction mixture was freeze-dried to give a powder hydrolysate (hereinafter referred to as “enzyme degradation product of soybean extract” or “enzyme degradation product of soybean extract with high β-conglycinin content”).

A kokumi-conferring effect by the addition of each sample to a low-fat food was confirmed according to the method described in WO2008/139945. Specifically, low-fat milk (manufactured by Takanashi milk products Co., Ltd.) was divided into 60 ml portions, an evaluation sample (12 mg) was added to the portions, and mixed to give low-fat milk having a concentration of the evaluation sample of 200 mg/L. Three professional panelists evaluated the low-fat milk samples for their kokumi strength according to a rating method. The evaluation by the rating method was performed using the sensory evaluation scores shown in Table 2 as the standard.

TABLE 10

| evaluation sample | sensory evaluation score |
|---|---|
| No additive | 0.0 |
| soybean extract | 0.9 |
| soybean extract with high | 1.1 |
| β-conglycinin content | |
| enzyme degradation product of | 1.8 |
| soybean extract | |
| enzyme degradation product of | 2.8 |
| soybean extract with high | |
| β-conglycinin content | |

From the results shown in Table 10, the strongest taste enhancing effect was observed in an enzyme degradation product of soybean extract with high β-conglycinin content, and a soybean extract with high β-conglycinin content before enzymatic degradation did not show a taste enhancing effect.

### INDUSTRIAL APPLICABILITY

According to the present invention, it has been clarified that a particular peptide mixture obtained by hydrolyzing a composition containing β-conglycinin effectively enhances the taste of food. The peptide mixture of the present invention is useful in the food field, and use of the peptide mixture of the present invention can effectively enhance the taste of food, and can particularly effectively confer kokumi to food.

While the invention has been described in detail with reference to preferred embodiments thereof, it will be apparent to one skilled in the art that various changes can be made, and equivalents employed, without departing from the scope of the invention. Each of the aforementioned documents is incorporated by reference herein in its entirety.

1. A method of producing a food composition with an enhanced taste, comprising adding to a food composition a peptide mixture obtained by hydrolyzing with an enzyme a second composition comprising β-conglycinin as a main component, wherein the range of the molecular weight of said peptide mixture is 2.6-9.4 kDa as measured by a gel filtration method, and wherein the peptide mixture has a trichloroacetic acid (0.22M) solubilization rate of 12.1-25.4%.

2. The method according to claim 1, wherein the peak area of the peptide mixture is 4.5-42.0% of the total peak area.

3. The method according to claim 1, wherein said hydrolyzing is performed at pH 2-11 and/or a temperature of 4-70° C.

4. The method according to claim 1, wherein the second composition comprises not less than 80 wt % of β-conglycinin.

5. The method according to claim 1, wherein the second composition is produced from a soybean with a high content of β-conglycinin.

6. The method according to claim 5, wherein the soybean comprises 65 mg/g-400 mg/g of β-conglycinin in a dry weight.

7. A method of producing a food composition with an enhanced taste, comprising adding to a food composition a peptide mixture obtained by grinding and deoiling a soybean with a high content of β-conglycinin to give an extract, and hydrolyzing the extract with an enzyme under the conditions of pH 2-11 and/or a temperature of 4-70° C.

8. The method according to claim 1, wherein the enzyme is selected from the group consisting of bromelain, papain, protease M, trypsin, aroase, and combinations thereof.

9. The method according to claim 1, wherein the concentration of the peptide mixture in the food composition is 0.001-99 wt %.

10. A food composition with an enhanced taste, which is obtained by the method according to claim 1.

11. The food composition according to claim 10, which is a seasoning.

12. A method for enhancing a taste of food, comprising adding a to a food a peptide mixture obtained by hydrolyzing a composition comprising β-conglycinin as a main component with an enzyme.

13. The method according to claim 12, wherein the composition comprises not less than 80 wt % of β-conglycinin.

14. The method according to claim 12, wherein the peptide mixture comprises peptides having a molecular weight range of 2.6-9.4 kDa as measured by a gel filtration method.

15. The method according to claim 12, wherein the peptide mixture has a trichloroacetic acid (0.22M) solubilization rate of 12.1-25.4%.

16. The method according to claim 12, wherein the enzyme is selected from the group consisting of bromelain, papain, protease M, trypsin, aroase, and combinations thereof.

17. The method according to claim 12, wherein the composition is prepared from a soybean with a high content of β-conglycinin.

18. The method according to claim 12, wherein the method confers kokumi to the food.

19. A peptide mixture obtained by grinding and deoiling a soybean with a high content of β-conglycinin to give an extract, and hydrolyzing the extract with an enzyme under the conditions of pH 2-11 and/or a temperature of 4-70° C.

20. A taste enhancing agent comprising a peptide mixture obtained by hydrolyzing, with an enzyme, a composition comprising not less than 80 wt % of β-conglycinin, which mixture comprises peptides having a molecular weight range of 2.6-9.4 kDa as measured by a gel filtration method, and wherein said mixture has a trichloroacetic acid (0.22M) solubilization rate of 12.1-25.4%.

21. A food composition comprising a peptide mixture obtained by hydrolyzing, with an enzyme, a second composition comprising not less than 80 wt % of β-conglycinin under the conditions of pH 2-11 and/or a temperature of 4-70° C., said mixture
(1) comprises peptides having a molecular weight range of 2.6-9.4 kDa as measured by a gel filtration method,
(2) shows a peak area of the peptide of 4.5-42.0% of the total peak area, and
(3) has a trichloroacetic acid (0.22M) solubilization rate of 12.1-25.4%.
